(19) United States
(12) Patent Application Publication
(10) Pub. No.: US 2025/0187070 A1
(43) Pub. Date: Jun. 12, 2025

(54) UNIVERSAL METHOD FOR SYNTHESIS OF METALLIC NANOPARTICLES VIA SCANNING PROBE LITHOGRAPHY

(71) Applicant: NORTHWESTERN UNIVERSITY, Evanston, IL (US)

(72) Inventors: Chad A. Mirkin, Wilmette, IL (US); Vinayak P. Dravid, Evanston, IL (US); Carolin B. Wahl, Evanston, IL (US)

(21) Appl. No.: 18/840,338

(22) PCT Filed: Feb. 22, 2023
(86) PCT No.: PCT/US2023/013594

§ 371 Date: Aug. 21, 2024

Related U.S. Application Data
(60) Provisional application No. 63/312,711, filed on Feb. 22, 2022.

(51) Int. Cl. B22F 1/054; B22F 9/22; B82Y 40/00

(52) U.S. Cl. CPC B22F 1/054; B22F 9/22; B82Y 40/00

(57) ABSTRACT

A method for forming metal or metal oxide nanoparticles on a substrate can include depositing a precursor ink on a hydrophobic surface of a substrate to form nanoreactors on the hydrophobic surface. The precursor ink includes a metal precursor and a non-coordinating polymer dissolved in a solvent. The process can then include evaporating the solvent from the nanoreactors, wherein upon evaporation of the solvent, the polymer and the metal precursor phase separate and the metal precursor aggregates on a surface of the nanoreactors. After the solvent is evaporated, the polymer is removed to thereby leave the aggregated metal precursor in contact with the hydrophobic surface. The resulting aggregated metal precursor is then annealed to form the metal or metal oxide nanoparticle.

### CROSS-REFERENCE TO RELATED APPLICATION

The benefit of priority to U.S. Provisional Patent Application No. 63/312,711 filed Feb. 22, 2022, is hereby claimed and the disclosure is incorporated herein by reference in its entirety.

### FIELD

The disclosure is related to methods of forming metal and/or metal oxide nanoparticles, and more particularly to universal methods of forming metal and/or metal oxide nanoparticles that can occur irrespective of element-specific chemistry.

### BACKGROUND

Throughout history, the materials that have been used and relied on have evolved over time, slowly becoming more complex. The progression from the stone tools used by early-man to the composite synthetic materials used today took centuries due to the massive parameter space that materials encompass. For instance, when one considers the 91 metal elements in the periodic table, and all possible combinations of them, a nearly infinite number of possible materials exist. This is particularly true at the nanoscale where small changes in size or shape, even at a fixed chemical composition, can dramatically change a material's properties.

### SUMMARY

The ability to rapidly synthesize and subsequently screen materials for desired properties is needed. A nanoscale scanning probe lithography approach has been developed that, through the deposition of polymeric nanoreactors and thermal annealing, enables the preparation of “megalibraries” of as many as 5 billion positionally encoded nanomaterials with distinct chemistries, including metallic or ionic nanoparticles and perovskites. These libraries can be tailored to encompass a wide variety of alloy and phase-separated nanoparticles that are comprised of as many as 7 different elements with up to four phases and six interfaces. Importantly, one megalibrary contains more new well-defined inorganic materials than chemists cumulatively have produced and characterized to date and can be used to identify new materials and catalysts for important chemical transformations. In addition, important insight into how thermodynamic phases form in polyelemental nanoparticles has been obtained, and design rules for engineering heterostructures in polyelemental nanoparticles has been established. A new high-throughput structure, catalysis, and luminescence characterization techniques have been developed that match the unprecedented speed of megalibrary synthesis.

### BRIEF DESCRIPTION OF THE DRAWINGS

FIG. 1A is a schematic illustration of a conventional method for nanoparticle synthesis.

FIG. 1B is a schematic illustration of the method of the disclosure.

FIG. 1C includes HAADF images of the precursor aggregates on the nanoreactor surface in a nanoreactor array, a single nanoreactor, the precursor aggregate, and a high-resolution image of the amorphous aggregate. Inset: FFT of the corresponding ABF image. Scale bars: 2 μm, 100 nm, 20 nm, 5 nm, respectively

FIG. 1D includes HAADF images of the precursor aggregates after polymer removal in a nanoreactor array, a single nanoreactor, the precursor aggregate, and a high-resolution ABF image of partially crystalline aggregate. Inset: FFT. Scale bars: 2 μm, 100 nm, 20 nm, 5 nm, respectively

FIG. 1E includes HAADF images of the resulting nanoparticle in a nanoreactor array, a single nanoparticle, a zoomed-in image of the nanoparticle, and a high-resolution image of the crystalline particle with an amorphous oxide surface due to atmospheric exposure. Inset: FFT of the corresponding ABF image. Scale bars: 2 μm, 100 nm, 20 nm, 5 nm, respectively.

FIG. 2 is an illustration with representative images of various single-component nanoparticles that can be synthesized the method of the disclosure. The white borders delineate elements that can be synthesized as both metals and oxides. Scale bars: 10 nm.

FIGS. 3A to 3E are HAADF images and EDS maps of multicomponent nanoparticles formed by the method of the disclosure.

FIG. 4A-4B are HAADF images of Pt particles formed by a conventional SPCBL method in which the particle is formed within a polymer nanoreactor, with (A) showing formation in PEO-b-P2VP, (B) showing formation in P2VP, and (C) showing formation in PEG 400.

FIG. 5 is a HAADF image of Pt nanoparticles synthesized by the method of the disclosure using polystyrene in the precursor ink.

FIG. 6A includes HAADF and ABF images of W after annealing at 240° C. using the method of the disclosure and comparing to a conventional method using P2VP as the polymer, showing that the W remained amorphous in both instances.

FIG. 6B includes HAADF and ABF images of the W nanoparticles of FIG. 6A, after annealing at 600° C. showing that the W was polycrystalline.

FIG. 6C includes TEM images and SAED patterns confirming that W nanoparticles were formed by each method.

### DETAILED DESCRIPTION

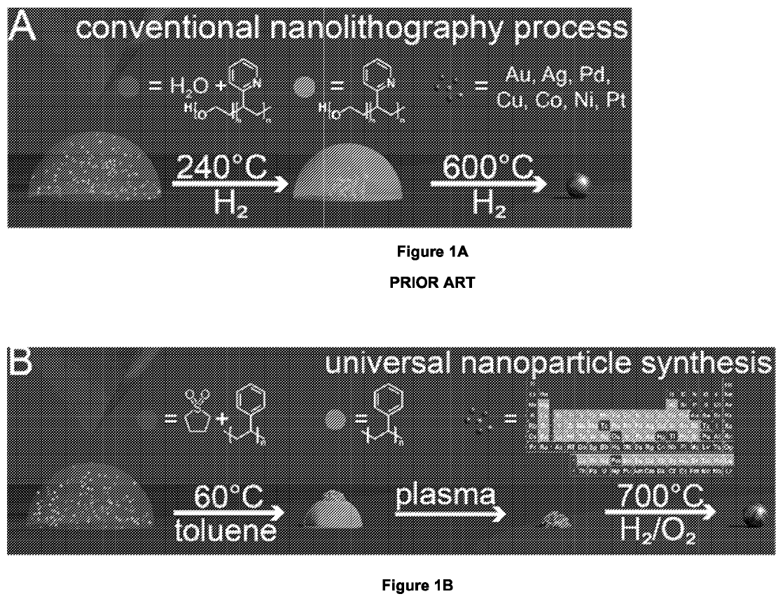

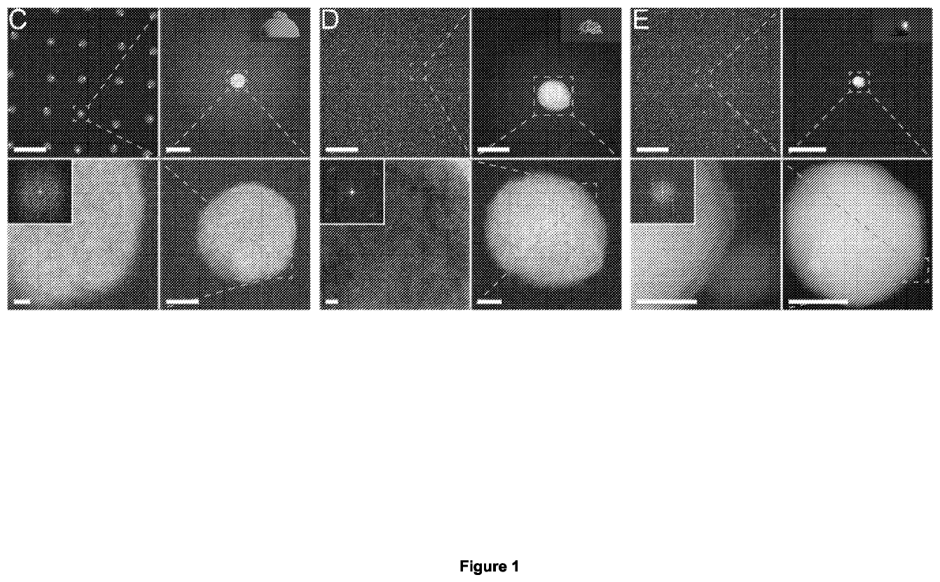

Referring to FIG. 1A, conventional processes for forming nanoparticles using nanoreactors formed using lithographic methods generally involves the formation of nanoparticles within the nanoreactor. For example, as is illustrated in FIG. 1A, a nanoreactor precursor ink is deposited on a substrate and then subjected to a two-stage heating process to first aggregate the metal components within the nanoreactor and then convert the aggregated metal components into a nanoparticle, all formed within the nanoreactor. Commonly, such processes utilize coordinating polymers, such as the block copolymer PEO-b-P2VP.

In contrast, as is illustrated in FIG. 1B, the method of the disclosure provides a universal method in which particles form on the surface of the nanoreactor, as opposed to within the nanoreactor. The precursor ink of the disclosure includes a non-coordinating polymer or polymer mixture, a metal precursor, and a polar, nonvolatile solvent or solvent mixture. The components of the precursor ink should be selected such that polymer or polymer mixture and the metal precursor are soluble in the solvent or solvent mixture. The precursor ink can be nonaqueous. Reference herein will be made to a polymer, a metal precursor and a solvent and should be understood to include a single polymer, a single metal precursor, and/or a single solvent and/or a polymer mix, a mixture of metal precursors with the same or different metals, and a mixture of solvents.

Non-coordinating polymers are polymers that do not coordinate to the metal precursor used. Non-coordinating polymers suitable for use in the methods of the disclosure are soluble, either on its own or in a polymer mix, in the solvent or solvent mixture, and immiscible with the metal precursors in the absence of solvent. The non-coordinating polymer can be polystyrene (PS) or polystyrene based, for example. For example, the polymer can be a mixture of 500 Da PS with 600 Da sulfonic acid-terminated PS. It was found that this polymer mixture is soluble in sulfolane-DMSO mixtures to at least 200 mg/ml when the fraction of sulfonic acid-terminated PS is at least 2% of the total amount of polymer.

The non-coordinating polymer can be present in the precursor ink in a total amount of amount of about 10 mg/mL to about 200 mg/mL, about 100 mg/ml to about 200 mg/ml about 10 mg/ml to about 50 mg/ml, about 35 mg/ml to about 125 mg/ml or about 15 mg/ml to about 75 mg/ml. Other suitable amounts include about 10, 20, 30, 40, 50, 60, 70, 80, 90, 100, 110, 120, 130, 140, 150, 160, 170, 180, 190, and 200 mg/ml and any values therebetween or ranges defined by these values. For example, the precursor ink can include about 50 mg/ml of polymer.

The metal precursor can be, for example, a metal salt. For example, a metal nitrate or metal halide of the desired metal to be formed in the nanoparticle can be used. The metal precursor can include combinations of metal nitrates and metal halides having different metals, for example, to form multicomponent metallic nanoparticles. For example, the metals contained in the metal precursor can be one or more of Mg, Al, Ca, Sc, Ti, V, Cr, Mn, Fe, Co, Ni, Cu, Zn, Ga, Ge, Sr, Y, Zr, Mo, Ru, Rh, Pd, Ag, Cd, In, Sn, Sb, Ba, Lu, Hf, Ta, W, Re, Ir, Pt, Au, Pb, Bi, La, Ce, Pr, Nd, Sm, Eu, Gd, Th, Dy, Ho, Er, Tm, Yb. All of the above can form metal oxide nanoparticles. In addition, all elements that can be reduced by hydrogen and are nonvolatile in their metallic state, i.e., Fe, Co, Ni, Cu, Mo, Ru, Rh, Pd, Ag, Sn, W, Re, Ir, Pt, Au, Pb, Bi, can form metallic particles, so that metallic, metal oxide, and mixed metal/metal oxide nanoparticles can be prepared. Methods of the disclosure can also be used with metal precursors containing Be, Tc, Os, Hg, TI, Ra, or any actinides

The metal precursor can be present in the precursor ink in a total amount of about 5 mM to about 200 mM. Other concentrations are contemplated herein so long as the metal precursor remains soluble in the solvent. For example, the precursor ink can include 30 mM metal precursor. The metal precursor can be one or more metal precursors. For example, the metal precursor can include two or more metal precursors each with different metals for forming a multi-component nanoparticle. For precursor inks having two or more metal precursors, each can be included in a relative amount determined by the desired multi-component nanoparticle to be formed.

The solvent is polar and nonvolatile. The solvent is selected to dissolve the metal precursor and the polymer. The solvent can be, for example, 1,3-dimethyl-2-imidazolidone (DMI), propylene carbonate (PC), or sulfolane (SF). For example, the solvent can be sulfolane with 1-10% dimethyl sulfoxide (DMSO) to decrease the melting point of sulfolane to below room temperature.

The precursor ink is deposit onto a hydrophobic surface to form nanoreactors on the surface. For example, the precursor ink can be coated on hydrophilic scanning probe lithography tips and deposited on a hydrophobic surface by repeatedly contacting the hydrophobic surface with scanning probe lithography tips to form a pattern of nanoreactors on the hydrophobic surface. The dwell time can be used to control the resulting size of the nanoparticle by controlling the amount of precursor ink transferred to the substrate. The hydrophobic surface can be, for example, a hydrophobic coating deposited on a substrate or a hydrophobic substrate itself without a coating. For example, the hydrophobic surface can be a substrate functionalized with perfluorinated phosphonic acids. For example, the hydrophobic surface can be a surface or substrate having phosphonic acid modification. The substrate can be any substrate that is thermally stable, flat, and hydrophobic, or modifiable by hydrophobic coatings. For example, the substrate can have surfaces modified by plasma-polymerizing perfluorinated carbons onto them. For example, substrate can be TiO₂, Al₂O₃, or Ta₂O₅ functionalized with phosphonic acids. The substrate can be any thermally stable metal oxide. For example, the substrate can be ITO. For example, the substrate can be a carbon-based surface modified with perfluorinated polymer films.

Once deposited, the solvent in the nanoreactors evaporates and phase separation between the polymer or polymer mixture and the metal precursor occurs, causing the metal precursor to aggregate on the nanoreactor surface. Aggregation enables the conversion of the metal precursor into a single nanoparticle. It has advantageously been observed that this aggregation and conversion to a single nanoparticle can occur using method of the disclosure irrespective of any element-specific chemistry. The aggregation process can be performed at room temperature up to below the boiling point of the solvent. For example, the temperature can be up to 80° C. The aggregation process can be performed with exposure to a solvent vapor, such as toluene. For example, the aggregation process can be facilitated, for example, by heating at 60° C. in toluene vapor. The polymer can be removed by solvent annealing, for example. For example, THF can be used.

FIG. 1C is an HAADF image of the precursor aggregates on a nanoreactor surface, showing the nanoreactor array, a single nanoreactor, the precursor aggregate, and a high-resolution image of the amorphous aggregate. The inset is a FFT of the corresponding ABF image.

Next, the polymer is removed so that the metal precursor aggregate directly contacts the hydrophobic surface. The polymer can be removed by a variety of processes depending on the thermal and chemical stability of the substrate and/or the metal precursor. For example, plasma treatment can be used to remove the polymer while also reducing or oxidizing the surface layer of the precursor aggregates. Suitable treatment times and plasma power are determinable within the knowledge of those skilled in the art for removing the polymer completely, without etching the metal precursor aggregate. For example, the plasma treatment can be a 5-minute treatment of a 100 W H₂ plasma to remove the polymer and reduce the surface layer of the precursor aggregates. For example, the plasma treatment can be a 1-minute treatment of a 100 W O₂ plasma to remove the polymer layer and oxidize the surface layer of precursor aggregates, which can be useful in preparing metal oxide nanoparticles. Alternatively, a very mild plasma (for example, 5 W for 5-10s) can be used for sensitive surfaces or substrates and the remainder of the polymer can be removed at 60° C. in a high vacuum (<10⁻⁶ torr). Other temperature and vacuum (pressure) conditions are contemplated herein and are generally selected based on the relative vapor pressures of the polymer and the metal precursors, such that the polymer can evaporate but the metal precursor cannot. In generally, lower temperatures can used at lower pressures.

FIG. 1D includes HAADF images of the precursor aggregates after polymer removal, showing the nanoreactor array, a single nanoreactor, the precursor aggregate, and a high-resolution ABF image of partially crystalline aggregate. The inset is an FFT of the corresponding ABF image.

Once the polymer is removed, the precursor aggregate is transformed into a single nanoparticle by thermal annealing. For example, for metal nanoparticles, metals can be reduced by H₂ while annealing. It has been observed that higher temperatures can improve yield. The temperature for annealing to form metal nanoparticles can be selected to be at least greater than the decomposition temperature of the of the metal precursor and less than a temperature at which the metal precursor evaporates. For precursor inks having multiple metal precursors, the annealing can be performed at a temperature at least greater than the highest one of the decomposition temperatures of the metal precursors and at least lower than the lowest evaporation temperature of the metal precursors. For example, the thermal annealing for forming metallic nanoparticles can be about 400° C. to about 800° C. for many metal precursors and substrates. For example, nonvolatile metallic particles can be formed from metal precursor aggregates by annealing at 700° C. for 12 h in H₂. Consideration for selection of the annealing temperature should also be made to the thermal stability of the substrate and temperatures at which the substrate is unstable should be avoided.

The process of annealing to form metal oxide nanoparticles can include a first annealing at a temperature at or near a decomposition temperature of the metal precursor and a second annealing at a temperature that is higher than the decomposition temperature, but below the evaporation temperature of the metal precursor and/or below the thermal stability limit of the substrate. Temperatures at or near a decomposition temperature of the metal precursor can be, for example, equal to or up to (higher or lower) 20%, or 10%, or 5%, or 2% or 1% and any values therebetween of the decomposition temperature of the metal precursor. For precursor inks comprises multiple metal precursors the highest decomposition temperature of the metal precursors and the lowest evaporation temperature of the metal precursors can be taken into consideration in selecting a suitable first and second annealing temperature. For example, metal oxide nanoparticles can be formed from the metal precursor aggregates by first annealing at 400° C. for 6 h and then 700° C. for 18 h in O₂, followed by cooling to room temperature at a rate of 50° C./h. For example, the second stage annealing can be at the highest possible temperature without being above the evaporation temperature of the metal precursor and/or the thermal stability limit of the substrate. For example, the second annealing temperature can be about 600° C. to about 800° C.

The total annealing time can depend on the temperature used. Longer times are generally needed with lower temperatures. If the time is too short, the formed particles have irregular shapes. Longer times have not been observed to affect the outcome.

It has been observed that improved formation of the nanoparticles can be achieved by using the fastest possible heating rates. For example, the furnaces used for the heating steps can be preheated to the target temperature to obtain a fast rate of heating.

FIG. 1E includes HAADF images of the resulting nanoparticle, showing the nanoparticle array, the single nanoparticle, a zoomed-in image of the nanoparticle, and a high-resolution image of the crystalline nanoparticle with an amorphous oxide surface due to atmospheric exposure. The inset is an FFT on the corresponding ABF image.

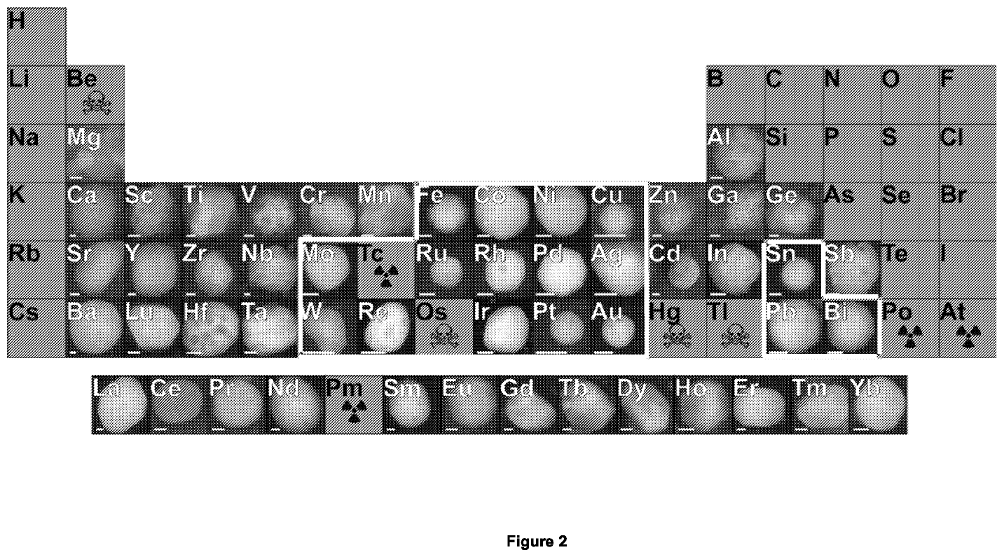

The methods of the disclosure were used to synthesize nanoparticles from almost every stable metal in the periodic table. FIG. 2 is an illustration showing the metals that have been synthesized into nanoparticles using the method of the disclosure and those which can be synthesized in both metals and metal oxides are outlined in white.

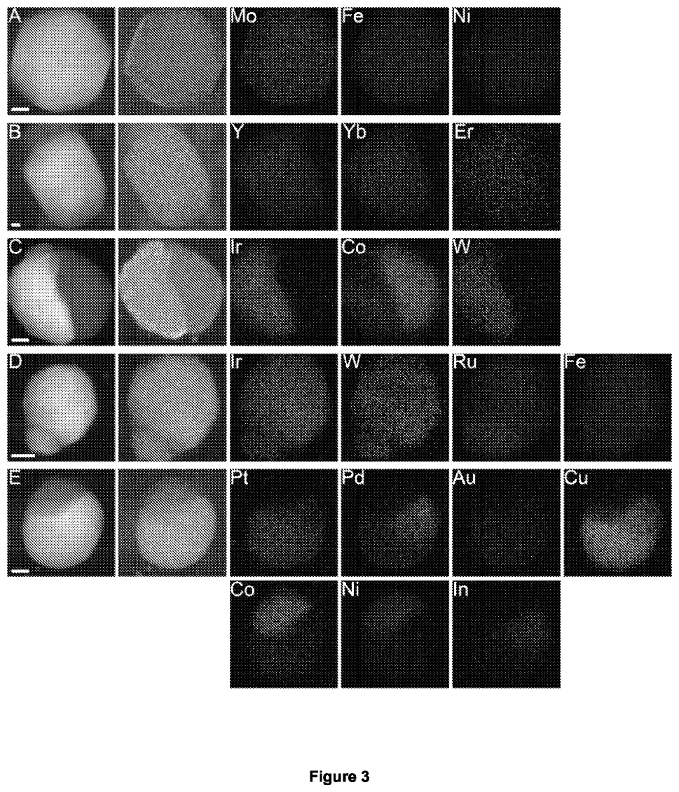

Certain metals, such as the alkali metals, have insufficient thermal stability to be transformed from the precursor aggregate into a nanoparticle as a single-component system. However, they may be stabilized in multimetallic crystals. In general, this method allows for the synthesis of any multicomponent nanoparticle from the single-component building blocks, with compositions that are tunable by adjusting the metal precursor concentration in the ink. FIG. 3 shows the various multicomponent nanoparticles that have been synthesized by the method of the disclosure. HAADF images and EDS maps of (A) MO₄₇Fe₂₈Ni₂₅, (B) Y₇₅Yb₂₁ Er₄, (C) Ir₄₂CO₄₈W₁₀ (D) Ir₄₄W₁₀RU₂₃Fe₂₃, (E) Pt₁₃Pd₁₂AU₃CU₄₀CO₁₄Ni₁₅In₄. Scale bars in FIG. 3 are each 5 nm. In each case, the precursor ink contained 50 mg/mL of a polymer mixture of 2 wt. % 600 Da sulfonic acid-terminated PS in 500 Da PS. The solvent was 1% DMSO in SF in each case. The total metal precursor concentration in each was 30 mM. Of that, the relative metal precursor ratios were as follows: (A) 47% (Mo(OAc)₂)₂, 28% FeCl₃, 25% Ni(NO₃)₂; (B) 75% Y(NO₃)₃, 21% Yb(NO₃)₃, and 4% Er(NO₃)₃; (C) 42% H₂IrCl₆, 48% CoCl₂, 10% WCl₄; (D) 44% H₂IrCl₆, 10% WCl₄, 23% RuCl₃, 23% FeCl₃; (E) 13% H₂PtCl₆, 12% Pd(NO₃)₂, 3% HAuCl₄, 40% Cu(NO₃)₂, 14% CoCl₂, 15% Ni(NO₃)₂, 4% InCl₃. The particles in A, C, D, and E were annealed at 700° C. for 12 h in H₂. The particles in B were annealed at 400° C. for 6 h and 700° C. for 18h in O₂.

The method of the disclosure can advantageously provide a nanoscale scanning probe lithography approach that enables the preparation of “megalibraries” of as many as 5 billion positionally encoded nanomaterials with distinct chemistries, including metallic or ionic nanoparticles and perovskites. These libraries can be tailored to encompass a wide variety of alloy and phase-separated nanoparticles that are comprised of as many as 7 different elements with up to four phases and six interfaces. Importantly, one megalibrary contains more new well-defined inorganic materials than chemists cumulatively have produced and characterized to date and can be used to identify new materials and catalysts for important chemical transformations. In addition, important insight into how thermodynamic phases form in polyelemental nanoparticles has been obtained, and design rules for engineering heterostructures in polyelemental nanoparticles has been established. A new high-throughput structure, catalysis, and luminescence characterization techniques have been developed that match the unprecedented speed of megalibrary synthesis.

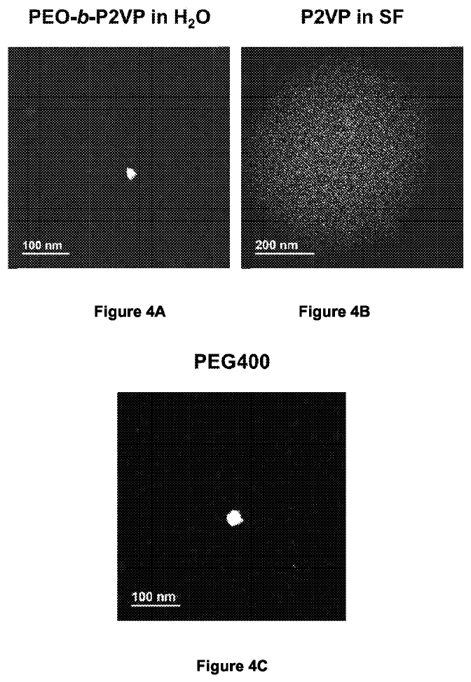

FIGS. 4A-4C illustrates the formation of Pt nanoparticles using the conventional method of forming the nanoparticle within a nanoreactor. The previously described system of using the block polymer PEO-b-P2VP in H₂O is shown in FIG. 4A. FIGS. 4B and 4C show the same process used in FIG. 4A, but with the individual components of the block polymer in the precursor. As seen in FIG. 4B, particle formation did not occur in P2VP. Particle formation in PEG was found to occur, but it was observed that PEG alone had limited applicability to noble metals and was not as universally applicable as compared to the method of the disclosure.

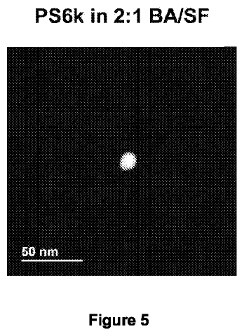

FIG. 5 shows Pt nanoparticle formation using polystyrene in a method of the disclosure. The HADDF image was taken after thermal treatment of the nanoreactors at 240° C. for 12 h in H₂. It was found that polymers that interact with the metal precursors, such as P2VP, inhibit the formation of single particles. Using polymers that have very strong interactions with metals (e.g., poly(acrylic acid), poly(acrylonitrile), or poly(4-cyanostyrene), inhibits particle formation in every metal, including Au. The methods of the disclosure deliberately use non-coordinating polymers to enhance particle formation. It has been found that using polymers such as PS that are also immiscible with the metal precursor resulted in the described aggregation of the metal precursor upon solvent evaporation. This results in a fundamentally different nanoparticle formation process, that relies on thermal sintering on the substrate surface as opposed to the nucleation and growth process inside of the nanoreactor reported in previous technology.

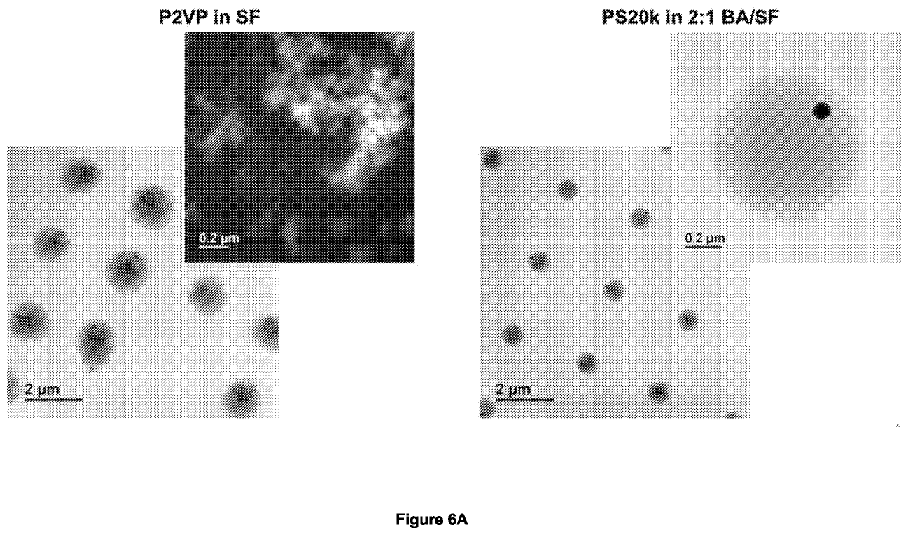

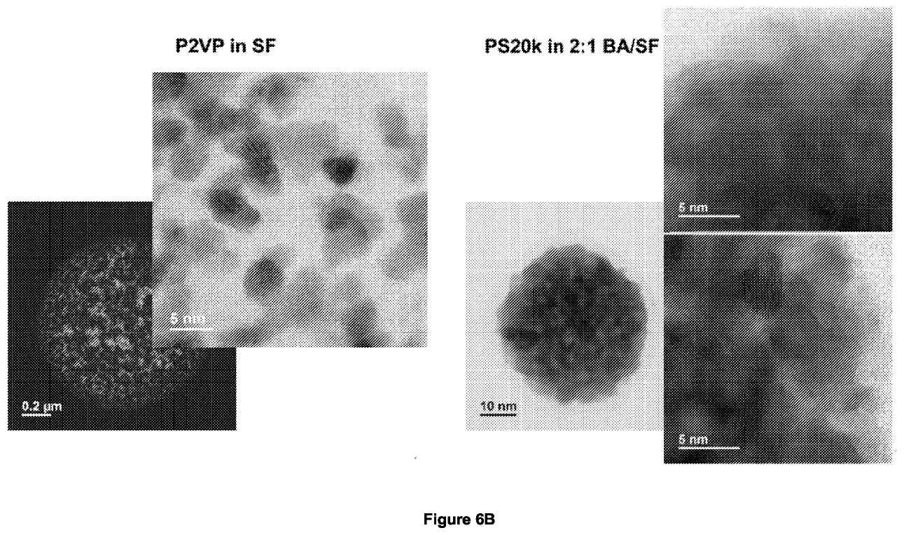

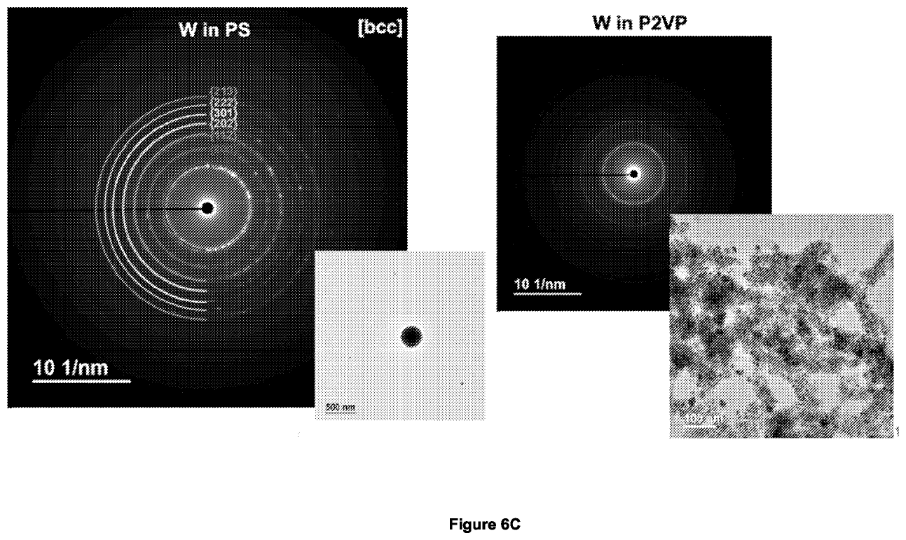

Referring to FIGS. 6A and 6B, for W, it was observed that annealing at 600° C. was needed to form polycrystalline structures both with conventional processes using P2VP and a process in accordance with the disclosure using PS. The nanostructures formed after annealing at 400° C. remained amorphous. As shown in FIG. 6C, both P2VP polymer and PS20K was able to produce W nanoparticles.

The foregoing description is given for clearness of understanding only, and no unnecessary limitations should be understood therefrom, as modifications within the scope of the disclosure may be apparent to those having ordinary skill in the art.

All patents, patent applications, government publications, government regulations, and literature references cited in this specification are hereby incorporated herein by reference in their entirety. In the case of conflict, the present description, including definitions, will control.

Throughout the specification, where the compounds, compositions, methods, and/or processes are described as including components, steps, or materials, it is contemplated that the compounds, compositions, methods, and/or processes can also comprise, consist essentially of, or consist of any combination of the recited components or materials, unless described otherwise. Component concentrations can be expressed in terms of weight concentrations, unless specifically indicated otherwise. Combinations of components are contemplated to include homogeneous and/or heterogeneous mixtures, as would be understood by a person of ordinary skill in the art in view of the foregoing disclosure.

### REFERENCES

WO2011/068960
U.S. Pat. No. 11,534,831

1. A method for forming metal or metal oxide nanoparticles on a substrate, comprising:
depositing a precursor ink on a hydrophobic surface of a substrate to form nanoreactors on the hydrophobic surface, wherein the precursor ink comprises a metal precursor and a non-coordinating polymer dissolved in a solvent;
evaporating the solvent from the nanoreactors, wherein upon evaporation of the solvent, the polymer and the metal precursor phase separate and the metal precursor aggregates on a surface of the nanoreactors;
removing the polymer from the nanoreactors to thereby leave the aggregated metal precursor in contact with the hydrophobic surface; and
annealing the aggregated metal precursor to form the metal or metal oxide nanoparticles.

2. The method of claim 1, wherein the solvent is one or more of 1,3-dimethyl-2-imidazolidinone (DMI), propylene carbonate (PC), and sulfolane (SF), and/or wherein the polymer is polystyrene or polystyrene based.

3. (canceled)

4. The method of claim 1, wherein the metal precursor comprises a metal nitride and/or a metal halide.

5. The method of claim 1, wherein a metal of the metal precursor is one or more of Mg, Al, Ca, Sc, Ti, V, Cr, Mn, Fe, Co, Ni, Cu, Zn, Ga, Ge, Sr, Y, Zr, Mo, Ru, Rh, Pd, Ag, Cd, in, Sn, Sb, Ba, Lu, Hf, ta, W, Re, Ir, Pt, Au, Pb, Bi, La, Ce, Pr, Nd, Sm, Eu, Gd, Th, Dy, Ho, Er, Tm, and Yb.

6. The method of claim 1, wherein the metal precursor is present in the precursor ink in an amount of about 5 mM to about 20 mM.

7. The method of claim 1, wherein the polymer is present in the precursor ink in an amount of about 10 mg/ml to about 200 mg/ml.

8. The method of claim 1, wherein depositing the precursor ink comprises contacting the hydrophobic surface with scanning probe lithography tips coated in the precursor ink.

9. (canceled)

10. (canceled)

11. (canceled)

12. The method of claim 1, wherein evaporating the solvent comprises heating the nanoreactors to a temperature of room temperature to about 80° C.

13. The method of claim 1, wherein evaporating the solvent is performed with exposure to a solvent vapor.

14. The method of claim 13, wherein the solvent vapor is toluene or THF.

15. The method of claim 1, wherein removing the polymer comprises treating the nanoreactors with a plasma.

16. The method of claim 15, comprising treating the nanoreactors with the plasma in H₂.

17. The method of claim 15, wherein the plasma is O₂ plasma.

18. The method of claim of claim 15, further comprising heating under vacuum to remove the polymer.

19. The method of claim 1, wherein annealing the aggregated metal precursor comprises heating to a temperature at least greater than a decomposition temperature of the metal precursor and below a temperature at which the metal precursor evaporates.

20. The method of claim 1, wherein annealing the aggregated metal precursor comprises heating to a temperature of about 400° C. to about 800° C.

21. The method of claim 1, wherein annealing the aggregated metal precursor comprises annealing in H₂ to reduce the metal precursor to a metal nanoparticle.

22. The method of claim 1, wherein annealing the aggregated metal precursor comprises annealing in O₂ to convert the metal precursor to a metal oxide nanoparticle.

23. The method of claim 22, wherein heating in O₂ comprises a first annealing at a first temperature at or about the decomposition temperature of the metal precursor, and a second annealing at a second temperature above the decomposition temperature of the metal precursor and below a temperature at which the metal precursor evaporates.

24. The method of claim 1, wherein the metal precursor comprises at least two or more metal precursors each having a decomposition temperature, and annealing is performed at a temperature at or greater than the highest decomposition temperature of the two or more metal precursors.
